(19) United States
(12) Patent Application Publication
(10) Pub. No.: US 2013/0311700 A1
(43) Pub. Date: Nov. 21, 2013

(54) Extending Lifetime For Non-volatile Memory Apparatus

(71) Applicant: Chung-Jwu Chen, Taipei City (TW)

(72) Inventor: Chung-Jwu Chen, Taipei City (TW)

(21) Appl. No.: 13/476,011

(22) Filed: May 20, 2012

(51) Int. Cl. G06F 12/00

(52) U.S. Cl. 711/103; 711/E12.008

(57) ABSTRACT

A non-volatile memory apparatus includes non-volatile memory having a user block and a reserved block, a first connector for connecting to a host device, at least one second connector for connecting to a storage medium, and a first controller connected to the non-volatile memory, the first connector and the at least one second connector. Memory blocks of the storage medium are used as extra reserved blocks for the non-volatile memory apparatus. The first controller controls and remaps the user blocks and reserved blocks of the non-volatile memory, and the memory blocks of the storage medium.

### BACKGROUND OF THE INVENTION

1. Technical Field

The present invention relates to non-volatile memory apparatuses, and particularly to a solid state drive (SSD) with extended lifetime and related method.

2. Description of the Conventional Art

The SSD is one conventional non-volatile memory product. Because SSDs have advantages of light weight and resistance to shock/vibration, an increasing number of mobile devices are using SSDs. For example, the Google Chromebook includes an internal 16 GB SSD. Non-volatile memory products, such as SSDs, split physical storage space into two parts: a User Block and a Reserved Block. The User Block is the memory area currently under use for storing data, and the Reserved Block contains blocks used for replacing and/or remapping of bad blocks. When the Reserved Block is completely used up, the SSD enters Write Protect Mode, which prevents further writing to the SSD. At this point, the user must send the SSD back to the factory for maintenance in order to increase its use life.

In addition to the above, although current non-volatile memory technologies have increased capacity and are less expensive due to advances in manufacturing processes, reliability of non-volatile memory products, such as SSDs, is lower with critical dimension scale down. Thus, Program/Erase (P/E) cycle reductions also negatively affect SSD life expectancy.

### SUMMARY OF THE INVENTION

According to an embodiment of the present invention, a non-volatile memory apparatus comprises non-volatile memory comprising user blocks for data storage and reserved blocks, a first connector for connecting to a host device, at least one second connector for connecting to a storage medium, and a first controller connected to the non-volatile memory, the first connector and the at least one second connector, for controlling and remapping the user blocks and reserved blocks of the non-volatile memory, and the memory blocks of the storage medium. Memory blocks of the storage medium are used as extra reserved blocks for the non-volatile memory apparatus.

According to an embodiment of the present invention, a storage medium comprises non-volatile memory comprising a plurality of memory blocks, a connector for connecting to at least one non-volatile memory apparatus, and a controller for allocating at least one memory block of the plurality of memory blocks as a reserved block of the at least one non-volatile memory apparatus.

According to an embodiment of the present invention, a non-volatile memory system comprises a storage medium and at least one non-volatile memory apparatus. The storage medium comprises first non-volatile memory comprising a plurality of memory blocks, and a first connector. The at least one non-volatile memory apparatus comprises second non-volatile memory comprising user blocks and reserved blocks, a second connector for connecting to a host device, a third connector for connecting to the first connector of the storage medium, and a first controller for using at least one memory block of the plurality of memory blocks of the storage medium as reserved blocks of the non-volatile memory.

According to an embodiment of the present invention, a lifetime extending method for a non-volatile memory apparatus comprises: performing a block monitoring on the non-volatile memory apparatus to monitor if a number of spare blocks of the non-volatile memory apparatus is less than a preset spare blocks threshold; providing a low reserved block alert from the non-volatile memory apparatus to a storage medium through a connector when the number of spare blocks of the non-volatile memory apparatus is less than the preset spare blocks threshold; receiving a mapping table sent from the storage medium to a controller of the non-volatile memory apparatus; and generating an updated mapping table on the non-volatile memory apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a non-volatile memory system.

FIG. 2 is a flowchart of a process for extending lifetime of the non-volatile memory apparatus using the storage medium.

FIG. 3 is a flow chart of a process for extending lifetime of the non-volatile memory apparatus using the storage medium.

### DETAILED DESCRIPTION

For the reasons mentioned above, the disclosure describes embodiments of a non-volatile memory apparatus, such as an SSD, that has a bad block management mechanism using an external storage medium connected to the SSD for increasing life expectancy of the SSD. An external storage medium may be connected to the non-volatile memory apparatus, and the non-volatile memory apparatus may use memory blocks of the external storage medium as extra reserved blocks of the non-volatile memory apparatus. Therefore, the storage volume may be not increased for the non-volatile memory apparatus under this purpose.

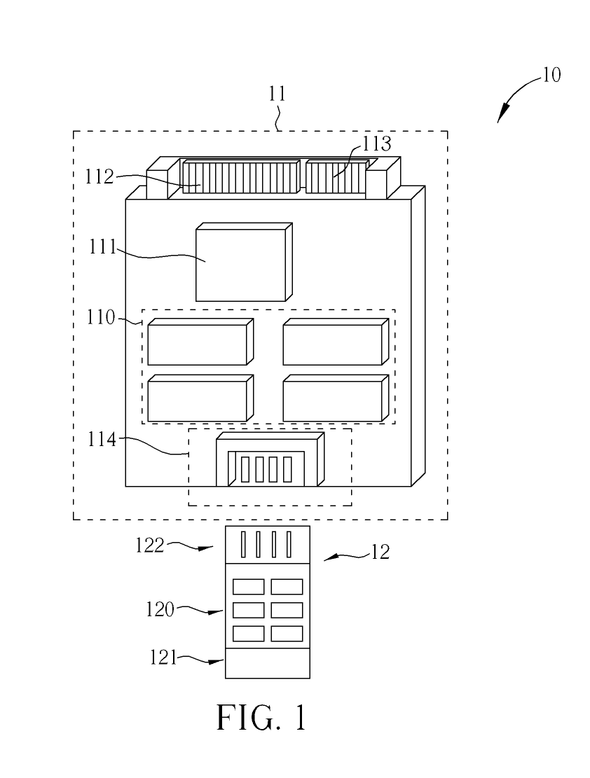

Please refer to FIG. 1, which is a diagram illustrating a non-volatile memory system 10. The non-volatile memory system 10 comprises at least one non-volatile memory apparatus 11 and a storage medium 12. The non-volatile memory apparatus 11 comprises non-volatile memory 110, such as flash memory, a controller 111, a first connector 113, a power connector 112, and at least one second connector 114. The first connector 113, the power connector 112, and the at least one second connector 114 all connect to the controller 111 for at least passing signals from/to a connected host or the storage medium 12. And, the non-volatile memory 110 is also connected to the controller 111 for data transferring. Memory blocks of the non-volatile memory 110 may be split into User Blocks and Reserved Blocks, as described above. In another preferred embodiment of this invention, the non-volatile memory 110 may comprise User Blocks only. The non-volatile memory apparatus 11 may be a solid state drive (SSD), and the first connector 113 may be a Serial Advanced Technology Attachment (SATA) connector, or other such connector for connecting the non-volatile memory apparatus 11 to the host, such as a motherboard of a personal computer. The power connector 112 may be for receiving power from the host. The at least one second connector 114 coupled to the controller 111 may comprise any combination of Universal Serial Bus (USB) connectors, Secure Digital (SD) connectors, micro SD connectors, mini SD connectors, or other similar technology connectors, and may also include a network connector(s), such as an RJ-45 connector, or a proprietary connector(s), for connecting to a network drive. The at least one second connector 114 is used for connecting to the storage medium 12, so that the non-volatile memory apparatus 11 may use the storage medium 12 as an extended flash device for increasing the Reserved Blocks of the non-volatile memory apparatus 11, so as to extend the life of the non-volatile memory apparatus 11. In other words, memory blocks of the storage medium 12 are used to provide extra reserved blocks for the non-volatile memory apparatus 11. The controller 111 connects to the non-volatile memory 110, the first connector 113 and the at least one second connector 114, and controls operation of the non-volatile memory apparatus 11, including at least read/write operation, wear-leveling, and bad block remapping of the user blocks and reserved blocks of the non-volatile memory 110, and the memory blocks of the storage medium 12.

The storage medium 12 may comprise non-volatile memory 120, a controller 121, and a connector 122. The non-volatile memory 120 may include User Blocks and Reserved Blocks, as described above. In the preferred embodiment of the invention, the User Blocks of the storage medium 12 may be used for increasing the Reserved Blocks of the non-volatile memory apparatus 11. The controller 121 controls operation of the storage medium 12, including at least read/write operation, wear-leveling, and bad block remapping. The connector 122 may comprise any combination of Universal Serial Bus (USB) connectors, Secure Digital (SD) connectors, micro SD connectors, mini SD connectors, or other similar technology connectors, and may also include a network connector(s), such as an RJ-45 connector, or a proprietary connector(s), for connecting to a network device. The non-volatile memory apparatus 11 and the storage medium 150 each store a corresponding mapping table for mapping logical addresses to physical addresses thereof.

The non-volatile memory apparatus 11 includes firmware for determining operating parameters thereof, such as number of spare blocks in the Reserved Block of the non-volatile memory 110. The number of spare blocks may be recorded in Self-Monitoring, Analysis and Reporting Technology (S.M.A.R.T.) attributes of the non-volatile memory apparatus 11. The number of spare blocks parameter can be used to alert a user of the non-volatile memory apparatus 11 when the number of spare blocks is approaching zero. For example, a preset spare blocks threshold may be set, and the number of spare blocks parameter may be compared with the preset spare blocks threshold to determine whether to alert the user. If the number of spare blocks parameter has value lower than the preset spare blocks threshold, then the non-volatile memory apparatus 11 may alert the user. Alerting the user may be performed in a variety of ways. For example, a light emitting diode (LED) may be installed in the non-volatile memory apparatus 11, and the LED may be lit to indicate that the number of spare blocks in the Reserved Block is lower than the preset spare blocks threshold. In another example, the firmware may transmit an alert signal to a host device using the non-volatile memory apparatus 11, e.g. a personal computer, and software of the host device may alert the user based on the received alert signal. For example, an audible and/or visual alert may be issued through speakers and/or a display connected to the host device.

When the user has been alerted of the preset spare blocks threshold being crossed, the user may choose to connect the storage medium 12 to the non-volatile memory apparatus 11 through the second connector 114. For example, if the second connector 114 is an SD connector, the user may connect an SD card to the second connector 114 to expand the Reserved Block of the non-volatile memory apparatus 11.

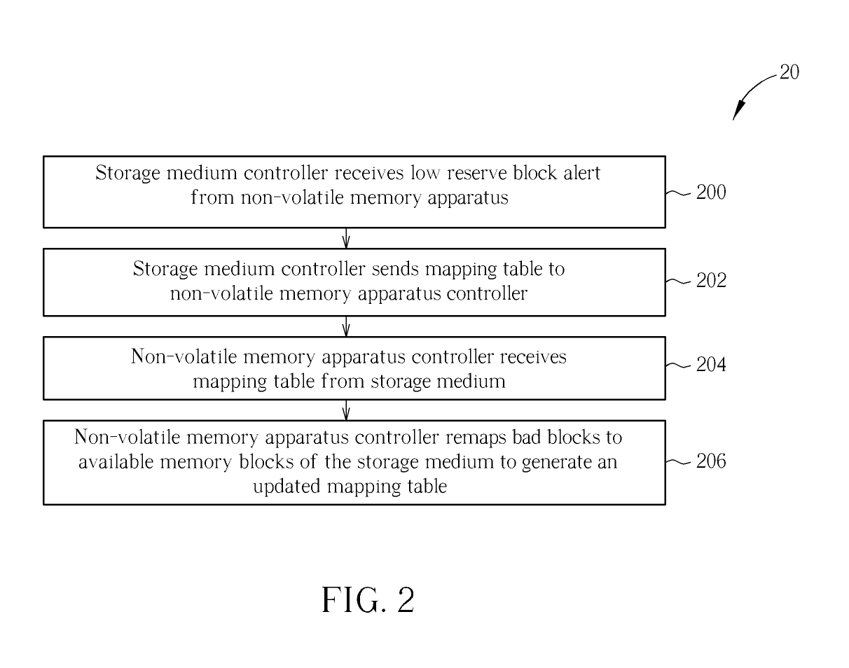

Please refer to FIG. 1 and FIG. 2. FIG. 2 is a flowchart of a process 20 for extending lifetime of the non-volatile memory apparatus 11 using the storage medium 12. The process 20 is described with reference to the non-volatile memory system 10 of FIG. 1, and comprises the following steps:

Step 200: Storage medium controller receives low reserved block alert from non-volatile memory apparatus;

Step 202: Storage medium controller sends mapping table to non-volatile memory apparatus controller;

Step 204: Non-volatile memory apparatus controller receives mapping table from storage medium; and

Step 206: Non-volatile memory apparatus controller remaps bad blocks to available memory blocks of the storage medium to generate an updated mapping table.

If the storage medium 12 is the only storage device connected to the non-volatile memory apparatus 11 through the second connector 114, the controller 121 sends the mapping table of the storage medium 12 to the controller 111 of the non-volatile memory apparatus 11. Then, the controller 111 uses the mapping table to assign available memory blocks of the storage medium 12 for use as reserved blocks of the non-volatile memory apparatus 11. In this way, life of the non-volatile memory apparatus 11 can be extended. In another preferred embodiment of the present invention, when the second connector 114 is a network connector(s), such as an RJ-45 connector or a proprietary connector(s), the connected device for extending the reserved blocks of the non-volatile memory apparatus 11 may be a server or any other Internet storage space. In such situation, the mapping table of the non-volatile memory apparatus 11 may be updated by the server instead of the controller 111, and the server then sends back the updated mapping table to the controller 111. This preferred embodiment of the present invention considers the ability of the storage medium 12 to handle the process of mapping table updating for the controller 111 of the non-volatile memory apparatus 11.

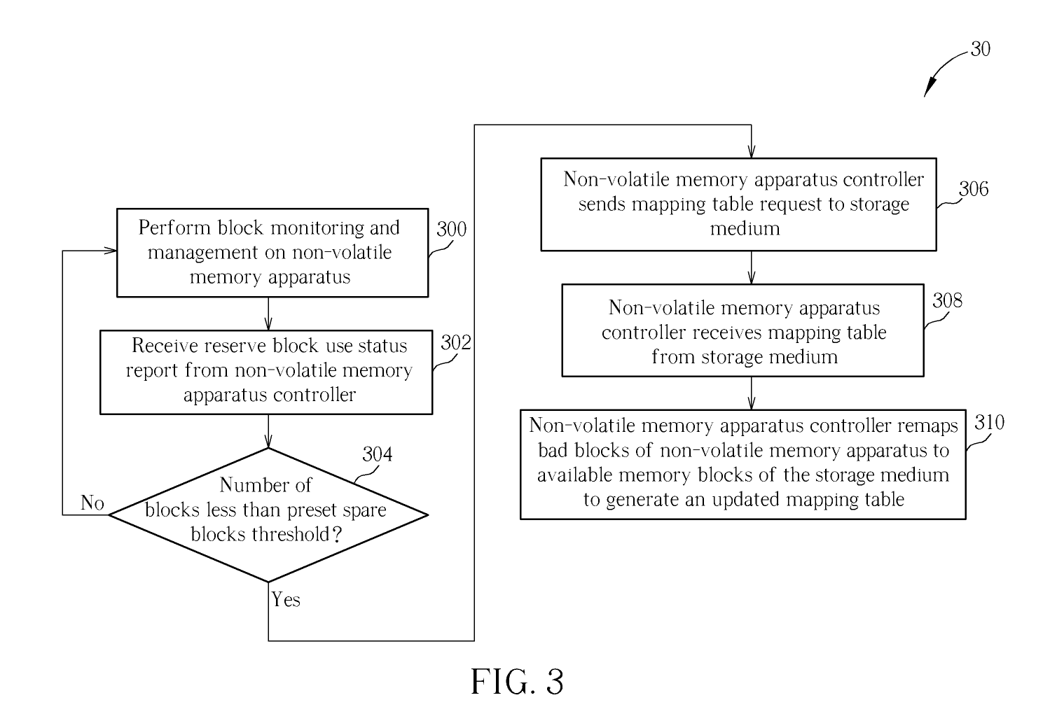

Please refer to FIG. 3, which is a flow chart of a process 30 for extending lifetime of the non-volatile memory apparatus 11 using the storage medium 12. The process 20 is described with reference to the non-volatile memory system 10 of FIG. 1, and comprises the following steps:

Step 300: Perform block monitoring and management on non-volatile memory apparatus;

Step 302: Receive reserved block use status report from non-volatile memory apparatus controller;

Step 304: Check if the number of spare blocks is less than the preset spare blocks threshold. If no, go to step 300; if yes, go to step 306;

Step 306: Non-volatile memory apparatus controller sends mapping table request to storage medium;

Step 308: Non-volatile memory apparatus controller receives mapping table from storage medium; and

Step 310: Non-volatile memory apparatus controller remaps bad blocks of non-volatile memory apparatus to available memory blocks of the storage medium to generate an updated mapping table.

In the process 30, steps 300, 302, and 304 may be performed by either the non-volatile memory apparatus 11 or by the storage medium 12. If the storage medium 12 performs step 300 and 302, the storage medium 12 may receive periodic reports from the non-volatile memory apparatus 11 regarding how many spare reserved blocks are remaining. Then, in step 304, the storage medium 12 may determine whether or not the number of spare blocks is less than the preset spare blocks threshold. If the non-volatile memory apparatus 11 performs steps 300, 302, and 304, the non-volatile memory apparatus 11 may periodically or constantly monitor status of the number of spare blocks. For example, the controller 111 may monitor S.M.A.R.T. attributes to determine the number of spare blocks, and compare the number of spare blocks with the preset spare blocks threshold to determine whether or not to use memory blocks of the storage medium 12 for reserved blocks.

Although steps 306-310 are described in terms of the non-volatile memory apparatus 11, steps 306-310 may also be performed by the storage medium 12. For example, the storage medium 12 may request that the non-volatile memory apparatus 11 send its mapping table in step 306. Then, the storage medium 12 may receive the mapping table from the non-volatile memory apparatus 11. The storage medium 12 may then rewrite the mapping table of the non-volatile memory apparatus 11 to allocate memory blocks of the storage medium 12 to the non-volatile memory apparatus 11 as reserved blocks. Finally, the updated mapping table indicating reserved blocks of the non-volatile memory apparatus 11 may be transmitted to the non-volatile memory apparatus 11 for the non-volatile memory apparatus 11 to use.

In some configurations, the storage medium 12 may only include reserved blocks, with no user blocks. For example, a manufacturer could produce a dedicated reserved block expansion card specifically for use with the expandable non-volatile memory apparatus 11.

In some configurations, the storage medium 12 may be a network drive, and the controllers 111, 121 of the non-volatile memory device 11 and the storage medium 12 may communicate using a network protocol, such as TCP/IP.

In some configurations, the storage medium 12 may act as a reserved block expansion region for multiple non-volatile memory apparatuses. The controller 121 of the storage medium 12 may coordinate mapping tables across the multiple non-volatile memory apparatuses, allocating different reserved blocks to different non-volatile memory apparatuses, and keeping the mapping tables synchronized across the multiple devices. Or, one of the non-volatile memory apparatuses may act as a coordinator for coordinating mapping tables across multiple non-volatile memory apparatuses and multiple storage media. Or, a dedicated server may perform the above described coordination.

In some configurations, a non-volatile memory apparatus 11 may include both a network connector and another storage medium connector (e.g. SD, micro SD, mini SD, CF, etc.). If a network connection between the non-volatile memory apparatus 11 and the storage medium 12 is lost, or cannot be established, the non-volatile memory apparatus may use a second storage medium connected to the storage medium connector to provide reserved blocks. Or, if the second storage medium has no more reserved blocks available for use by the non-volatile memory apparatus 11, the non-volatile memory apparatus 11 may attempt to establish a network connection with the storage medium 12 to access reserved blocks on the storage medium 12.

In the above embodiments, a storage medium provides reserved blocks to a non-volatile memory apparatus that is low on spare reserved blocks. By expanding the number of reserved blocks available to the non-volatile memory apparatus, lifetime can be extended long past the point where all reserved blocks of the non-volatile memory apparatus are used up.

Those skilled in the art will readily observe that numerous modifications and alterations of the device and method may be made while retaining the teachings of the invention.

What is claimed is:

1. A non-volatile memory apparatus comprising:
non-volatile memory comprising user blocks for data storage and reserved blocks;
a first connector for connecting to a host device;
at least one second connector for connecting to a storage medium, wherein memory blocks of the storage medium are used as extra reserved blocks for the non-volatile memory apparatus; and
a first controller connected to the non-volatile memory, the first connector and the at least one second connector, for controlling and remapping the user blocks and reserved blocks of the non-volatile memory, and the memory blocks of the storage medium.

2. The non-volatile memory apparatus of claim 1, wherein the first controller uses the memory blocks of the storage medium as extra reserved blocks when number of the reserved blocks of the non-volatile memory apparatus is less than a preset spare blocks threshold.

3. The non-volatile memory apparatus of claim 2, wherein the first controller determines whether the number of the reserved blocks of the non-volatile memory apparatus is less than the preset spare blocks threshold.

4. The non-volatile memory apparatus of claim 1, wherein the first controller is configured to request a mapping table from a second controller of the storage medium, and allocate reserved blocks of the mapping table as reserved blocks for use by the non-volatile memory apparatus to generate an updated mapping table.

5. The non-volatile memory apparatus of claim 1, wherein the first controller is configured to detect a number of the spare reserved blocks of the non-volatile memory, compare the number to the spare blocks threshold, and issue an alert when the number is less than the preset spare blocks threshold and no storage medium is connected to the non-volatile memory apparatus.

6. The non-volatile memory apparatus of claim 1, wherein the second connector is a network connector, and the storage medium is a network drive.

7. A non-volatile memory system comprising:
a storage medium comprising:
first non-volatile memory comprising a plurality of memory blocks; and
a first connector; and
a non-volatile memory apparatus comprising:
second non-volatile memory comprising user blocks and reserved blocks;
a second connector for connecting to a host device;
a third connector for connecting to the first connector of the storage medium; and
a first controller for remapping the user blocks by using at least one of the plurality of memory blocks of the storage medium.

8. The non-volatile memory system of claim 7, wherein the at least one of the plurality of memory blocks of the storage medium comprises at least one reserved block of the first non-volatile memory.

9. The non-volatile memory system of claim 7, wherein the storage medium further comprises a second controller.

10. The non-volatile memory system of claim 7, wherein the first controller determines whether a number of reserved blocks of the non-volatile memory apparatus is less than a preset spare blocks threshold, and the first controller allocates the at least one memory block of the storage medium as a reserved block of the non-volatile memory apparatus when the number of reserved blocks of the non-volatile memory apparatus is less than the preset spare blocks threshold.

11. The non-volatile memory system of claim 7, wherein the first controller requests a mapping table from the second controller, allocates reserved blocks of the mapping table as reserved blocks for use by the non-volatile memory apparatus to generate an updated mapping table, and sends the updated mapping table to the controller of the storage medium.

12. The non-volatile memory system of claim 7, wherein the first connector and the third connector are network connectors.

13. A lifetime extending method for a non-volatile memory apparatus, comprising:
performing a block monitoring on the non-volatile memory apparatus to monitor if a number of spare blocks of the non-volatile memory apparatus is less than a preset spare blocks threshold;
providing a low reserved block alert from the non-volatile memory apparatus to a storage medium through a connector when the number of spare blocks of the non-volatile memory apparatus is less than the preset spare blocks threshold;
receiving a mapping table sent from the storage medium to a controller of the non-volatile memory apparatus; and
generating an updated mapping table on the non-volatile memory apparatus.

14. The lifetime extending method of claim 13, wherein the step of generating an updated mapping table on the non-volatile memory apparatus comprises:
remapping bad blocks of the non-volatile memory apparatus to available memory blocks of the storage medium.
